(19) United States
(12) Patent Application Publication
(10) Pub. No.: US 2008/0055700 A1
(43) Pub. Date: Mar. 6, 2008

(54) Laser Source Using Coherent Beam Recombination

(75) Inventors: Jerome Bourderionnet, Chaville (FR); Arnaud Brignon, Bourg La Reine (FR); Sebastien Demoustier, Paris (FR); Daniel Dolfi, Orsay (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly-sur-Seine (FR)

(21) Appl. No.: 11/722,676

(22) PCT Filed: Dec. 19, 2005
(86) PCT No.: PCT/EP05/56893

§ 371 Date: Jun. 22, 2007

(30) Foreign Application Priority Data
Dec. 23, 2004 (FR) 0413838

(51) Int. Cl. G02F 1/03; G02B 26/06; G02F 1/11; G02F 1/01

(52) U.S. Cl. 359/256; 359/237; 359/279; 359/285

(57) ABSTRACT

A laser source comprises N incident laser beams, N equal to two at least, N single-mode spatial beam propagation media, each forming a propagation channel (gᵢ) for one laser beam, a system for coherent recombination at the exit of the N channels, in order to deliver a recombined laser beam (f_{R}) at the exit, and a phase control device (D) comprising N programmable phase-shifter elements (dᵢ) under closed-loop feedback control, one at the entry of each channel (gᵢ). The source also comprises a polarization control device (P) comprising N programmable polarization controllers (pᵢ) under closed-loop feedback control, one per channel, each controller being disposed between the associated phase-shifter element and channel.

### CROSS-REFERENCE TO RELATED APPLICATIONS

The present Application is based on International Application No. PCT/EP2005/056893, filed on Dec. 19, 2005, which in turn corresponds to French Application No. 0413838, filed on Dec. 23, 2004, and priority is hereby claimed under 35 USC §119 based on these applications. Each of these applications are hereby incorporated by reference in their entirety into the present application.

### FIELD OF THE INVENTION

The present invention relates to a laser source using coherent laser beam recombination.

The coherent recombination of N elementary laser beams consists in summing N coherent beams (or N*Q, in a two-dimensional configuration) which have each been propagated through a medium with single-mode spatial propagation.

This coherent recombination allows applications to be addressed that require a laser beam with high luminance, but also with high coherence and of a high optical quality (limited by diffraction). In particular, high-power fiber laser sources may thus be achieved.

The invention relates to laser sources using single-mode spatial propagation media, for example single-mode fibers. The beam optical quality is preserved during the recombination process.

The field of application of such laser sources is very extensive. Telemetry, permanent marking, active imaging, tack welding, free-space communications, notably communications in space, with the possibility of deflection of the laser beam or of correction of atmospheric interference.

A laser source using beam recombination comprises, in a known manner, several single-mode spatial propagation media disposed in parallel. In the case of a high-power laser source, the propagation media are gain media. In this way, the amplification required in order to supply a high-power beam is distributed over N gain media, which allows the limits of non-linearity and of flux carrying capability of a single gain medium to be exceeded.

The coherent recombination of the amplified beams at the exit of the gain media allows a beam to be obtained whose luminance is increased in the ratio of the square of the number of amplified beams, with respect to the luminance of a single amplified beam. In addition, the beam obtained preserves the property (optical quality) of being limited by diffraction.

The coherent beam recombination at the exit of N fiber amplifiers, or more generally at the exit of N propagation media, imposes phase-matching and polarization conditions on the N beams at the exit. The phase-matching conditions are determined so as to allow constructive interference of the N beams, in order to obtain maximum luminance at the output, or a deflection of the main lobe of the beam at the exit (optical phase-scanning antenna), or a correction for various disturbances: vibration, temperature, mechanical stress effects, etc.

Since coherent beam recombination assumes the adjustment of the phase, for each beam, a phase correction device is provided for each channel.

### BACKGROUND OF THE INVENTION

In practice, and as recalled in the U.S. Pat. No. 6,400,871, adaptive phase correction techniques are used, via correction devices such as electro-optic elements (LiNbO₃ or liquid crystal spatial light modulators), or piezo-electric elements (fiber wound around a piezo-electric element). Acousto-optic modulators may also be used, as described for example in the publication “Coherent beam combining and phase noise measurements of ytterbium fiber amplifiers”, by M M. Augst, Fan and Sanchez, Optics Letters, Vol. 29, No. 5, 1st March 2004. A fiber laser source is notably described that comprises two amplifier fibers, which are Yb (Ytterbium) doped fibers. The laser source comprises an acousto-optic modulator (Bragg cell) for each amplifier channel. The modulator allows the phase to be controlled, in order to allow the coherent recombination of the beams at the exit of the two channels.

These various active components used to bring the various beams into phase, in order to ensure the coherent recombination, are very sensitive to the polarization, especially when the propagation media are fibers. In this case, polarization-conserving fibers are used.

The use of these polarization-conserving fibers has however various drawbacks. They are costly, and these fibers are also very sensitive to torsion.

It is important that the polarization of each of the beams be controlled at the exit of each of the media, in order to make the coherent recombination more efficient, in other words to make the interferences perfectly constructive.

### SUMMARY OF THE INVENTION

One subject of the invention is a laser source using coherent beam recombination that does not have the various aforementioned drawbacks.

One subject of the invention is a laser source using coherent beam recombination that does not have any power limitation.

According to the invention, a laser source using coherent beam recombination comprises a phase control element and a polarization element at the entry of each propagation medium, and a feedback control loop of said elements as a function of the exit characteristics.

The invention therefore relates to a laser source comprising N laser beams, N equal to two at least, N single-mode spatial beam propagation media, each forming a channel for one laser beam, a system for coherent recombination at the exit of the N channels, in order to deliver a laser beam at the exit, and a phase control device comprising N programmable phase-shifter elements under closed-loop feedback control, one at the entry of each channel, characterized in that the source also comprises a polarization control device comprising N programmable polarization controllers under closed-loop feedback control, one per channel, each controller being disposed between the phase-shifter element and the associated channel.

Still other objects and advantages of the present invention will become readily apparent to those skilled in the art from the following detailed description, wherein the preferred embodiments of the invention are shown and described, simply by way of illustration of the best mode contemplated of carrying out the invention. As well be realized, the invention is capable of other and different embodiments, and its several details are capable of modifications in various obvious aspects, all without departing from the invention.

Accordingly, the drawings and description thereof are to be regarded as illustrative in nature, and not as restrictive.

### BRIEF DESCRIPTION OF THE DRAWINGS

FIG. 1 is an overview schematic diagram of a high-power laser source according to the invention;

FIG. 2 is an overview schematic diagram of a high-power laser source according to another embodiment of the invention;

FIG. 3 shows schematically the effect of a non-depolarizing medium on the polarization state of a laser beam;

FIG. 4 shows schematically the effects of a phase-shifter and of a polarization controller according to the invention;

FIGS. 5a to 5c show a polarization control element that can be used in a laser source according to the invention;

FIGS. 6a to 6c show a programmable phase-shifter element that can be used in a laser source according to the invention;

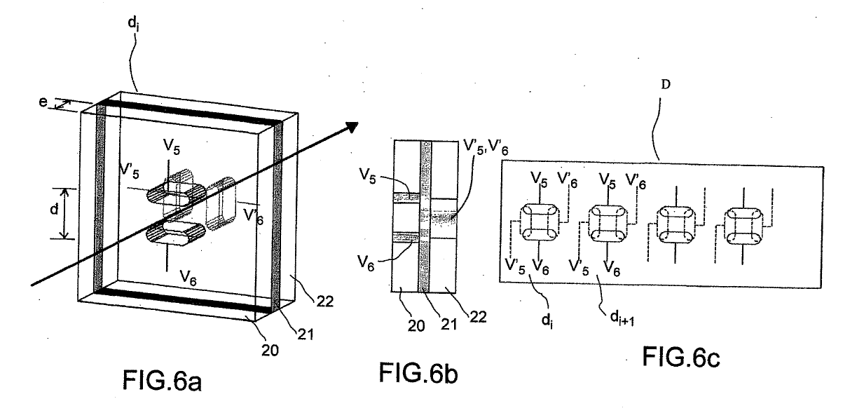

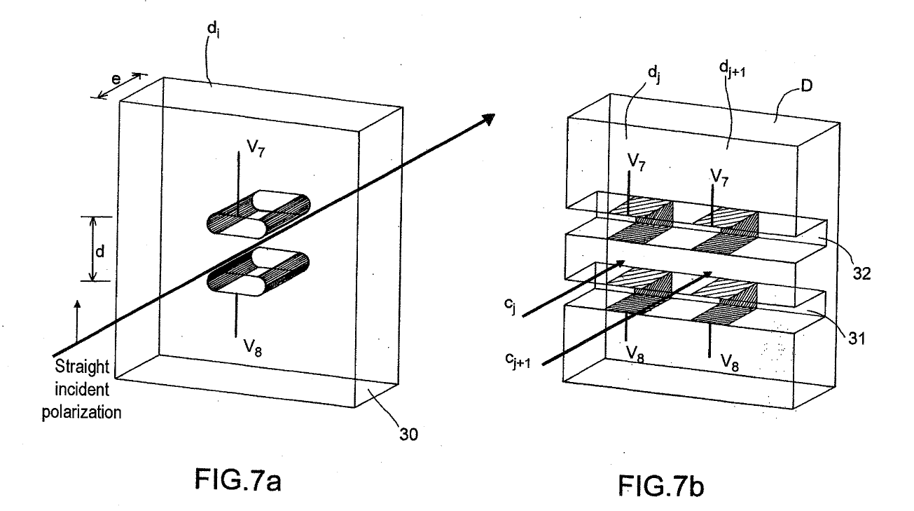

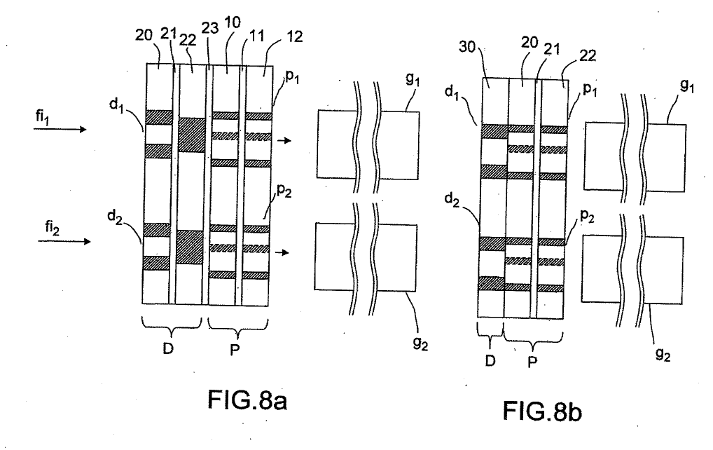

FIGS. 7a and 7b show a variant embodiment of the programmable phase-shifter element in FIGS. 6a to 6c;
and FIGS. 8a and 8b illustrate a programmable component for phase correction and for polarization control, which can be used in a laser source according to the invention.

### DETAILED DESCRIPTION OF THE DRAWINGS

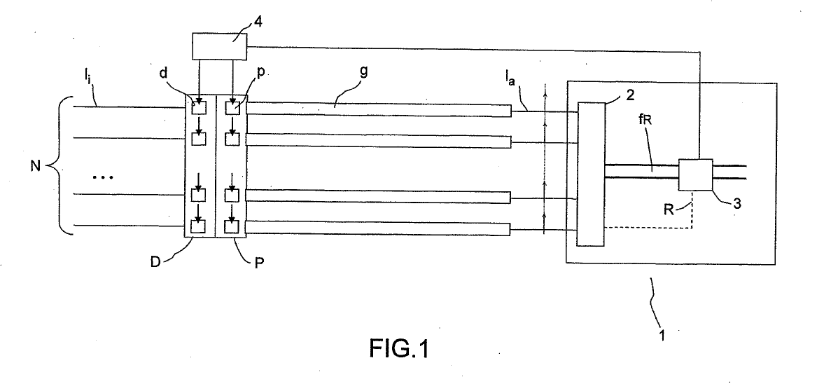

FIG. 1 is an overview schematic diagram of a laser source, according to the invention. This source comprises N single-mode spatial propagation channels g, a coherent recombination system 1, providing coherent recombination of the N laser beams lₐ at the exit of the N channels g, in order to deliver a recombined laser beam f_{R} at the exit. In one example, the coherent recombination system comprises a device 2 for reconditioning the beams (for example, an array of microlenses, in an example of coherent recombination of the beams in free space).

Each channel g receives an incident laser beam lᵢ. In the most general case, the N incident beams lᵢ are in a random polarization state, and have a random phase difference between them.

According to the invention, the laser source comprises a phase-shifter d and a polarization controller p, configured in cascade, at the entry of each propagation channel g.

Preferably, the N phase-shifters d are formed within the same component D in the form of a 1- or 2-dimensional matrix.

Preferably, the N polarization controllers p are formed within the same component P in the form of a 1- or 2-dimensional matrix.

Each of the phase-shifters d and each of the polarization controllers p is under closed-loop control, by a negative feedback signal which represents the phase and polarization matching efficiency of the N beams at the exit of the channels g.

In the case of a high-power laser source, the propagation channels are preferably amplifier fibers. These fibers are not necessarily polarization-conserving, which reduces the cost of the source.

The phase control and the polarization control according to the invention are separable functions. This allows several embodiments of the closed-loop control to be envisioned within a laser source according to the invention.

According to one embodiment shown schematically in FIG. 1, the phase and polarization feedback control is effected in a common manner. Such an embodiment can advantageously be implemented when the polarization state of the recombined beam at the exit can be random. In this case, the optimum condition for recombination is reached when all the beams are in the same polarization state at the exit. A feedback control based on the detection of the condition for optimum recombination can then be implemented which is, typically, the obtaining of an optimum intensity on the central lobe of the recombined beam. In this case, and as illustrated in FIG. 1, the output device 1 incorporates a feedback control module 3 which can for example comprise a device for measuring the intensity of the central lobe of the recombined laser beam f_{R}, and digital processing means implementing a feedback phase and polarization control algorithm, whose parameters will allow a maximum intensity to be obtained. Each phase-shifter element and polarization controller receives its own negative feedback signal that stems from this feedback control.

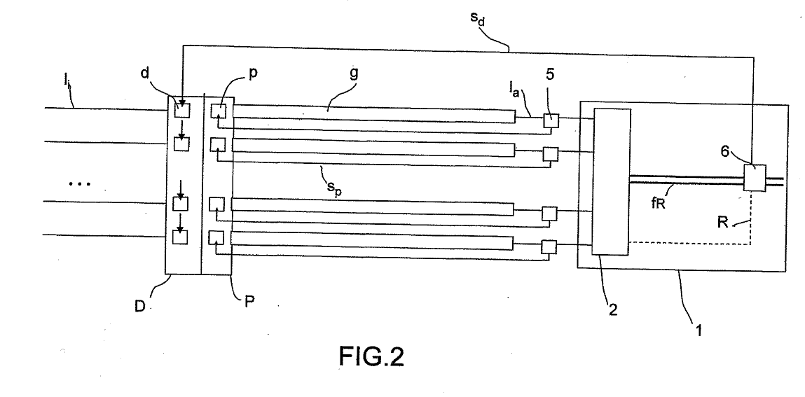

According to another embodiment shown schematically in FIG. 2, the negative phase feedback and the negative polarization feedback are generated by separate feedback control loops. Each function, phase control and polarization control, then possesses its own negative feedback device, each implementing its own appropriate feedback control algorithm.

In this embodiment, the polarization feedback control loop is formed on each channel g, by means of a feedback control device 5, disposed at the exit. This device 5 comprises a device for measuring polarization (polarimeter, or polarizer and photodiode for example) of a fraction of the exit signal, in order to generate a negative feedback signal Sₚ for the associated polarization controller p, by reference to an expected polarization state at the exit.

The phase feedback control loop is typically built into the output device, by means of a wavefront analyzer 6 on the recombined beam f_{R}. In one variant not shown, the phase feedback control loop can be formed in each channel g. This may notably be the case when a “phase ramp” is desired on the N beams at the exit.

The phase feedback control device (device 3 in FIG. 1 or 6 in FIG. 2) can use a reference phase R. This can, for example, be the phase of one of the N beams, or else an external reference phase.

The phase and polarization feedback control according to the invention notably allows a high-power laser source to be fabricated. In this case, the feedback control is arranged so that, at the exit of the channels g, the N amplified laser beams are in phase (delay of zero modulo 2π) and have the same polarization state.

Depending on the application targeted, the feedback control parameters may be different. For example, for tack welding applications, the feedback control is effected in order to impose a phase-shift ramp between the beams at the exit.

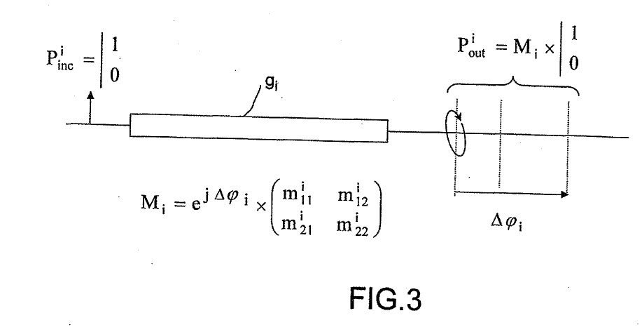

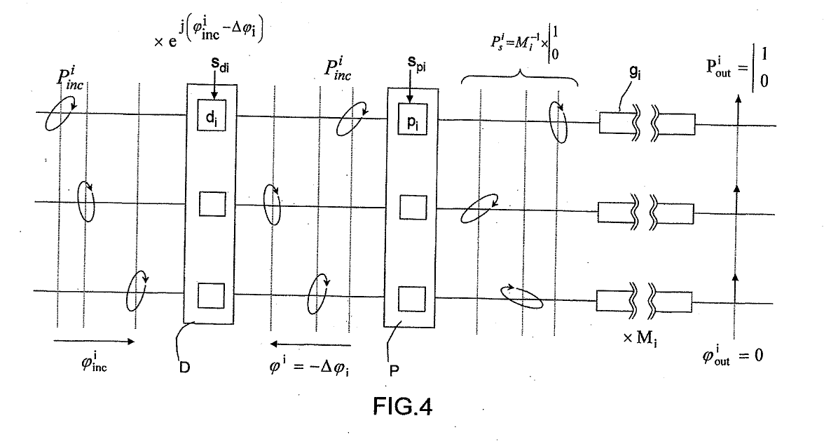

The principle of operation of a system according to the invention will be explained in relation to FIGS. 3 and 4.

FIG. 3 shows, in a general way, the effect of a medium gᵢ on the polarization state of a laser beam.

An incident laser beam with an incident polarization Pⁱ_{inc}=|₀¹ is considered.

The propagation medium gⱼ has a Jones matrix that may be written:

$$with {M}_{i} = {ⅇ}^{{jΔφ}_{i}} ( \begin{matrix}{m}_{11}^{i} & {m}_{12}^{i} \\ {m}_{21}^{i} & {m}_{22}^{i}\end{matrix} ) .$$

This Jones matrix of the medium gᵢ represents the modification of the polarization state of the light, with the complex coefficients mⁱ₁₁, . . . mⁱ₂₂ and of the phase shift, by the term Δφᵢ.

In a laser source according to the invention, it is desired that the beam at the exit of the medium gᵢ be in a given polarization state Pⁱₒᵤₜ.

In order to achieve this goal, the polarization state at the entry of the medium gᵢ must be: Pⁱ_{inc}=Mᵢ⁻¹Pⁱₒᵤₜ.

In other words, by controlling the polarization state at the entry of the medium gᵢ, the polarization state at its exit is controlled.

Furthermore, so that the beam at the exit of the medium gᵢ is in a given phase state, the phase shift Δφᵢ induced by the medium must also be controlled.

This is the principle used in the invention.

According to the invention, and as shown in FIG. 4, two optical elements are cascaded: a phase-shifter dᵢ and a polarization controller pᵢ, at the entry of each channel gᵢ.

The principle of operation of the invention is thus described by FIG. 4: the phase-shifter dᵢ associated with a channel gᵢ (the propagation medium), generates a delay on this channel gᵢ, in order to compensate for
the delay Δφᵢ introduced by this channel gᵢ,
the incident relative delay with the other channels, gᵢ₊₁, gᵢ₊₂, . . . and
the delay introduced by the polarization controller pᵢ.

The polarization controller pᵢ associated with the channel gᵢ transforms the incident polarization state Pⁱᵢₙ into a polarization state Pⁱₛ which will give, after propagation in the medium gᵢ, the desired polarization state Pⁱₒᵤₜ (vertical polarization in FIG. 4).

The 2 elements dᵢ and pᵢ are used in a closed-loop system with a feedback control of the N phase-shifter elements dᵢ and of the N polarization controllers pᵢ by an associated negative feedback signal sdᵢ or spᵢ, by means of a measurement device and an appropriate algorithm. It is shown that the recombined beam obtained at the exit has characteristics which represent the phase and polarization matching efficiency according to the invention.

The phase-shifter elements dᵢ and/or phase controllers pᵢ may be formed by any programmable device of the prior art, and notably by electro-optic devices (LiNbO₃, liquid crystal devices), or any other. The phase-shifter elements can also be acousto-optic elements (Bragg cells).

Preferably, for the polarization controller, an electro-optic controller will be used, such as that described notably in the patent FR 0215994, entitled: “Dispositif de contrôle dynamique de la polarisation d'une onde optique et procédé de fabrication d'un tel dispositif”. Such a controller notably has the advantage of being very efficient, of limiting the insertion losses, of having a very short response time and of being very compact.

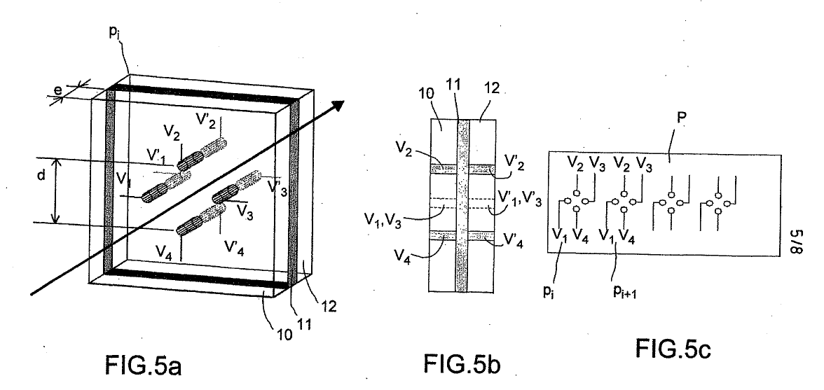

It typically comprises, as shown in FIGS. 5a (perspective) and 5b (profile), two plates with variable birefringence and orientable neutral axes 10 and 12, configured in cascade.

In the example shown, the electrodes are open metallized holes, passing through the whole plate thickness. In this case, an electrically insulating plate 11 must be provided between the two plates 10 and 12. This plate is typically a plate of silica (or of a material with low dielectric constant).

In the case where the holes are not through-holes, there is no problem of electrical insulation, and the two plates 10 and 12 can be cascaded on top of one another.

Each plate with variable birefringence and orientable neutral axis is made of an electro-optic material whose birefringence can be varied and neutral axis oriented under the effect of an electric field whose amplitude and/or orientation is modified by means of a set of at least three electrodes. In the example, the plate 10 thus comprises four electrodes V₁, V₂, V₃ and V₄. The plate 12 comprises four electrodes V′₁, V′₂, V′₃ and V′₄. The plates are disposed as illustrated in the figure.

If a ceramic PLZT is taken as electro-optic material, for example, it can be shown that the voltage Vπ required in order to obtain a phase shift of π in each of the plates, the necessary condition in order to allow an unlimited polarization control, may be written as:

$$V π = \sqrt{\frac{λ {d}^{2}}{{n}_{0}^{3} Re}} ,$$

where d is the inter-electrode spacing (typically of the order of 100 μm), e the thickness of the plate (typically of the order of 500 μm), no the refractive index of PLZT (2.4), and R its electro-optic coefficient (3.10⁻¹⁶ m²V²).

For these typical values, control voltages (to be applied to the electrodes) are obtained that are less than 100 volts.

Furthermore, the response time of such a component is of the order of a microsecond, which allows fluctuations in polarization of several hundreds of kilohertz to be compensated (matching the requirements of the application).

Depending on the material used, the control voltages may be lower, less than 30 volts. Materials such as KTN (Potassium Tantalate Niobate), or PZN (Pb(Zn_{1/3}Nb_{2/3})) may be mentioned.

If reference is again made to FIG. 4, a polarization controller such as is shown in FIGS. 5a and 5b leads to a phase shift that is a function of the respective birefringences φ₁ and φ₂ of the plates 10 and 12 of the component.

Indeed, the transfer matrix of such a polarization controller is given by:

$$M = {ⅇ}^{j \frac{{φ}_{1} + {φ}_{2}}{2}} \times ( \begin{matrix}cos \frac{{φ}_{1} - {φ}_{2}}{2} + jcos2θsin \frac{{φ}_{1} - {φ}_{2}}{2} & j sin 2 θsin \frac{{φ}_{1} - {φ}_{2}}{2} \\ jsin 2 θsin \frac{{φ}_{1} - {φ}_{2}}{2} & cos \frac{{φ}_{1} - {φ}_{2}}{2} - jcos2θsin \frac{{φ}_{1} - {φ}_{2}}{2}\end{matrix} )$$

with θ the common orientation of the neutral axes of the 2 plates.

Such a polarization controller therefore introduces a phase shift linked to the term

$${ⅇ}^{j \frac{{φ}_{1} + {φ}_{2}}{2}}$$

of the transfer matrix; which phase shift is taken into account in the phase control function according to the invention.

The fabrication details of such a controller can be found in the previously cited patent, and will not therefore be recalled here.

It allows a matrix formulation of the polarization control elements pᵢ, thus forming a matrix component P, which can be in one dimension, as illustrated in FIG. 5c, or in two dimensions.

According to one advantageous aspect of the invention, a similar component is used to produce the phase-shifter elements.

In a first embodiment shown in FIGS. 6a to 6c, a phase-shifter element dᵢ is formed by means of two plates with variable birefringences and fixed neutral axes, 20 and 22, each comprising a set of two electrodes, V₅, V₆, and V′₅, V′₆, respectively, and whose optical axes are crossed. In other words, the two plates are disposed so that their electrode sets are at 90 degrees with respect to one another.

The electrodes are formed by oblong metallized holes, in the thickness of the plate. In the example, the holes are through-holes. For this reason, a plate 21 of a material with low dielectric constant, typically a plate of silica, is provided between two cascaded plates, in order to isolate their respective electrodes.

Such a phase-shifter allows the desired control function to be provided in a laser source according to the invention, whatever the incident polarization state of the N beams. In other words, the phase-shifter dᵢ provides the phase-shifting function in an isotropic manner: the phase-shift applied is identical whatever the incident polarization state.

On the assumption that the birefringences of the 2 plates are equal (to φ), the Jones matrix of the phase-shifter may be written as follows:

$$M = ( \begin{matrix}{ⅇ}^{jφ} & 0 \\ 0 & 1\end{matrix} ) \times ( \begin{matrix}1 & 0 \\ 0 & {ⅇ}^{jφ}\end{matrix} ) = {ⅇ}^{jφ} \times ( \begin{matrix}1 & 0 \\ 0 & 1\end{matrix} )$$

In the invention, it is shown that the structure of such a phase-shifter may be derived from the polarization controller described in relation to FIGS. 5a to 5c and detailed in the previously cited French patent.

In particular, the material being considered (PLZT ceramic) is well suited to such an application by reason of its small hysteresis, its response time of the order of a μs, and its high electro-optic coefficient (R˜a few 10⁻¹⁶ m²V²) which allows short interaction distances to be used and the design of the components not to be limited to structures using guided optics.

The phase-shifter dᵢ illustrated in FIGS. 6a to 6c can be constructed in a similar manner to the polarization controller such as is described in the aforementioned French patent. More particularly, the following steps can be carried out:

In a first step, the two one-dimensional phase-shifter plates 20 and 22 are fabricated, by machining on 2 substrates 2 parallel oblong holes (by femtosecond laser or ultrasound machining).

In a second step, the holes are metallized (substrates completely metallized, then polished)

In a third step, an anti-reflective coating air/PLZT is applied on one face of each substrate, and the anti-reflective coating PLZT/glass on the other face. The air/PLZT coating provides the dual function of isolating the electrical contact tracks and the ceramic (stray capacitance effects), and of minimizing losses by reflection and interference effects. The PLZT/glass coating ensures the correct interfacing of each of the plates of PLZT 20 and 22, with the glass plate (or other insulator) 21 which will be inserted between the two.

In a fourth step, the deposition is performed of the contact tracks that will transport the control voltages to the machined electrodes.

Finally, in a last step, the assembly is carried out: the 2 ceramic plates are placed such that their sets of oblong holes are centered and disposed perpendicularly to one another and the glass plate 21 is inserted between these 2 plates 20 and 22.

Such a process easily allows a matrix configuration of phase-shifters dᵢ within a component D, as is shown in FIG. 6c.

It has been seen in relation to FIGS. 5a and 5b that the voltage required to obtain a phase shift of π for each of the 2 plates 20 and 22 is given by

$${V}_{π} = \sqrt{\frac{λ {d}^{2}}{{n}_{0}^{3} Re}}$$

where d is the spacing between the electrodes (typically 100 μm), e the thickness of each plate (typically 500 μm), no the refractive index of PLZT (2.4), and R the electro-optic coefficient of the ceramic (3.10-16 m²V²). For these typical values, control voltages below 100 volts are obtained, as previously indicated. As previously, other materials may be used, whose coefficient R is particularly well matched, notably KTN or PZT.

FIGS. 7a and 7b illustrate one variant embodiment of a phase-shifter according to the invention, simpler to produce and that is suitable in the case where the incident laser beams all have the same linear polarization. This is notably the case when the beams originate from one and the same laser source, delivering a linearly-polarized laser beam.

In this case, the function to be provided is simpler, since it now suffices to fabricate one plate with variable birefringence from 0 to 27 and with a fixed axis parallel to the axis of polarization of the incident beams.

The process is then applied in the same manner as hereinabove, except for the fact that only one plate 30 is now required. This plate will be chosen to have a greater thickness e than in the case of FIGS. 6a to 6c, in order to provide, typically, twice the thickness. It will have an anti-reflective coating air/PLZT on both faces, as previously indicated. It comprises a set of two electrodes V₇, V₈, formed as before, by two oblong holes, metallized through the thickness of the plate.

Another variant embodiment of the set of the two electrodes of a phase-shifter plate may be envisioned.

This variant is illustrated in FIG. 7b. It is notably advantageously applicable in the case where the phase-shifter element comprises a single plate. It leads advantageously directly to a matrix version of the component as illustrated in FIG. 7b, in the case of a one-dimensional matrix.

In this variant, within the thickness of the substrate, two parallel trenches 31 and 32 are dug into the thickness of the plate, by using a circular saw. Subsequently, the inside of these trenches is metallized selectively by masking, so as to form the electrodes V₇ and V₈, the first electrode V₇ in one trench, the trench 32 in the example, the second electrode V₈ in the other trench, the trench 31 in the example. The phase-shifter elements dⱼ, dⱼ₊₁ are thus formed along the axis of the trenches, whereas the direction of propagation of the beams incident on each element follows an axis cⱼ, cⱼ₊₁ perpendicular to the trench. It will be noted that the electrodes do not go right through the plate from one face to the other.

In order to obtain a two-dimensional matrix, the trench pairs 31, 32 must be multiplied within the height of the substrate.

In practice, the voltage required to obtain a phase shift of 2π is given by:

$${V}_{2 π} = \sqrt{\frac{2 λ {d}^{2}}{{n}_{0}^{3} Re}}$$

where d is the spacing between the electrodes (typically 100 μm), e the thickness of the plate, no the refractive index of PLZT (2.4), and R the electro-optic coefficient of the ceramic (3.10-16 m²V⁻²). For a thickness twice that of the previous case, the same maximum control voltage is obtained, lower than 100 volts.

FIGS. 8a and 8b illustrate an integrated “monolithic” phase and polarization control component which can then be advantageously used in the invention.

In the case illustrated in FIG. 8a, the two plates 20 and 22 of the phase-shifter are cascaded with the two plates 10 and 12 of the polarizer, while providing, if required, plates of silica 11, 13 and 21 in between (case of through-holes).

In the case illustrated in FIG. 8b, the plate 30 of the phase-shifter is cascaded with the two plates 10 and 12 of the polarizer, while providing, if required (through-holes through) a plate of silica 11 in between the two plates 10 and 12 of the polarization controller.

As illustrated in these figures, for 2 channels g₁ and g₂, this component can be advantageously fabricated in the form of a matrix. For each channel, for example g₁, a phase-shifter element, in the example d₁, cascaded onto a polarization control element, in the example p₁, is coupled at the entry.

The invention that has just been described is not however limited to the use of the components described in relation to FIGS. 5a to 5c, 6a to 6c, 7a and 7b, and 8a and 8b. In particular, a uniaxial phase-shifter may also be fabricated by using other technologies such as LiNbO₃, parallel alignment liquid crystals, etc.

An isotropic phase-shifter is then obtained by cascading 2 crossed uniaxial phase-shifters.

An isotropic phase-shifter can also be directly formed by using liquid crystal nano-droplet technology.

The invention that has just been described can also be advantageously applied in a system using polarization-conserving fibers. Indeed, such systems assume that the incident extinction coefficient on the fiber is high and that the polarization is well aligned in the axis of the fiber, in order that the polarization be conserved. If this is not the case, during the propagation, coupling of the desired polarization state toward the other polarization state of the fiber occurs. However, connection systems of the prior art hardly allow extinctions to exceed 25 dB whereas certain applications require 30 or 35 dB. Moreover, if the fiber is subjected to severe environmental disturbances such as vibrations or stresses, the extinction coefficient is observed to fall.

The application of a polarization controller according to the invention to such a system then allows a very high incident extinction coefficient on the fiber to be obtained, and its orientation to be well aligned on the axis of the fiber. Even if the fiber conserves the polarization in favorable environmental conditions, the controller allows more severe disturbances due to vibrations and to stresses exerted on the fiber to be corrected: it may be said that the fiber ensures a “rough” conservation of the polarization, whereas the polarization controller makes a fine correction to the residual variations, which allows higher extension coefficients to be reached under severe environmental conditions.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited by the definition contained in the appended claims and equivalent thereof.

1. A laser source comprising N incident laser beams, N equal to two at least, N single-mode spatial beam propagation media, each forming a propagation channel for one laser beam, a system for coherent recombination at the exit of the N channels, in order to deliver a recombined laser beam at the exit, and a phase control device comprising N programmable phase-shifter elements under closed-loop feedback control, one at the entry of each channel wherein the source also comprises a polarization control device comprising N programmable polarization controllers under closed-loop feedback control, one per channel, each controller being disposed between the associated phase-shifter element and channel.

2. The laser source as claimed in claim 1, wherein each of the N propagation media is an amplifier fiber.

3. The laser source as claimed in claim 2, wherein the fiber is not polarization-conserving.

4. The laser source as claimed in claim 1, wherein the N laser beams originate from the same emission source.

5. The laser source as claimed in claim 1, characterized in that it comprising, for each of the N channels, means for controlling the polarization of the beam disposed at the exit of the channel, for driving the polarization controller associated with said channel, and means for feedback controlling the phase of each of the beams as a function of the characteristics of the recombined beam.

6. The laser source as claimed in claim 1, comprising a system for analyzing the recombined beam, said system delivering at the output the control signals for the phase-shifter and polarization control elements.

7. The laser source as claimed in claim 6, wherein said analysis system measures the intensity of the central lobe of the recombined laser beam, and determines the correction to be applied to each of the polarization controllers and phase-shifter elements so that this intensity is the maximum intensity.

8. The laser source as claimed in claim 1, wherein the N channels are organized according to a matrix arrangement, in that the phase controller and the polarization controller are each of the matrix type.

9. The laser source as claimed in claim 1, wherein the programmable phase-shifter elements and/or the polarization control elements are electro-optic elements.

10. The laser source as claimed in claim 1, wherein the programmable phase-shifter elements are acousto-optic elements.

11. The laser source as claimed in claim 1, wherein each phase-shifter element comprises at least one plate of electro-optic material with birefringence that is variable under the effect of a programmable electric field, said plate comprising a set of two electrodes formed within the thickness of the plate.

12. The laser source as claimed in claim 11, wherein said electrodes each comprise an oblong metallized hole formed in the thickness of the plate.

13. The laser source as claimed in claim 11, wherein said electrodes each comprise a metallization deposited in a trench formed within the thickness of the plate.

14. The laser source as claimed in claim 11, wherein each phase-shifter element comprises a stack of two such plates of electro-optic material, disposed such that their respective sets of electrodes are perpendicular to one another.

15. The laser source as claimed in of claim 9, wherein each polarization control element comprises a stack of two plates of an electro-optic material with birefringence that is variable and neutral axis that is orientable under the effect of a programmable electric field, each plate comprising a set of at least three control electrodes.

16. The laser source as claimed in claim 15, wherein each phase-shifter element comprises at least one plate f electro-optic material with birefringence that is variable under the effect of a programmable electric field, said plate comprising a set of two electrodes formed within the thickness of the plate and the plates of the phase-shifter and polarization control elements are cascaded.

17. The laser source as claimed in claim 11, wherein said electro-optic material is a material chosen from amongst PLZT, PZT or KTN.

18. The laser source as claimed in claim 10, wherein each polarization control element comprises a stack of two plates of an electro-optic material with birefringence that is variable and neutral axis that is orientable under the effect of a programmable electric field, each plate comprising a set of at least three control electrodes.

19. The laser source as claimed in claim 11, wherein each polarization control element comprises a stack of two plates of an electro-optic material with birefringence that is variable and neutral axis that is orientable under the effect of a programmable electric field, each plate comprising a set of at least three control electrodes.
